(19) United States
(12) Patent Application Publication
(10) Pub. No.: US 2017/0154260 A1
(43) Pub. Date: Jun. 1, 2017

(54) LEARNING METHOD, COMPUTER-READABLE RECORDING MEDIUM, AND INFORMATION PROCESSING APPARATUS

(71) Applicant: FUJITSU LIMITED, Kawasaki-shi (JP)

(72) Inventors: Naoki Hamada, Kawasaki (JP); Takuya OHWA, Shinagawa (JP)

(73) Assignee: FUJITSU LIMITED, Kawasaki-shi (JP)

(21) Appl. No.: 15/336,925

(22) Filed: Oct. 28, 2016

(30) Foreign Application Priority Data
Nov. 27, 2015 (JP) 2015-232433

(51) Int. Cl. G06N 3/08; G06N 99/00

(52) U.S. Cl. CPC G06N 3/08; G06N 99/005

(57) ABSTRACT

An information processing apparatus executes 1 learning on each of a plurality of neural networks with regard to target data by duration of at least 1 epoch, and information processing apparatus executes a plurality times of loops of a specific algorithm, each of the plurality of times of loops changes a number of units of each of the plurality of neural networks. The information processing apparatus sets a plurality of learning durations for each of the plurality of neural networks based on a respective accuracy variance and a respective actual performance.

### CROSS-REFERENCE TO RELATED APPLICATION

This application is based upon and claims the benefit of priority of the prior Japanese Patent Application No. 2015-232433, filed on Nov. 27, 2015, the entire contents of which are incorporated herein by reference.

### FIELD

The embodiments discussed herein are related to a learning method, a learning program, and an information processing apparatus.

### BACKGROUND

As a technique for learning feature values, or the like, which are used in a predictor used in various fields, such as image processing, deep learning with a plurality of neural networks (hereafter, sometimes referred to as the NNs) in multiple layers is known. For NN learning, the number of units, the number of intermediate layers, or the like, is optimized to obtain the desired prediction accuracy; however, optimization may be time-consuming.

For example, an explanation is given by using an example where 1,000 NNs are optimized. In the case of a small-scale NN where the number of units is 5 to 100 and the number of intermediate layers is 1 to 3, if it takes one minute for one NN, it takes 17 hours (1 minute×1,000) for optimization. Furthermore, in the case of a large-scale NN where the number of units is 100 to 10,000 and the number of intermediate layers is 4 to 20, if it takes 12 hours for one NN, it takes 500 days (12 hours×1,000) for optimization.

In recent years, for small-scale NN learning, there has been a known technique for optimizing the network structure of NNs by using a genetic algorithm (hereafter, sometimes referred to as the GA). For example, for the reason that comparison of the predicted error of NNs is possible to some extent even if the learning epoch number indicating each of a plurality of learning durations being durations of the learning in each of the plurality of times of loops of the GA is decreased, NN learning for exploring the optimum number of units is terminated at a certain learning epoch number, whereby the learning time is shortened.

Furthermore, for large-scale NN learning, after the number of intermediate layers is previously determined, the optimum number of units is explored by using the GA or the like and, in addition, the coupling strength between units in different layers, or the like, is determined. Therefore, a technique is conducted such that, while exploration for the number of units is conducted multiple times by using the GA, NN learning is repeated in a loop of the GA by using a stochastic gradient method, or the like, whereby the optimum edge strength of the NN is explored.

Patent Literature 1: Japanese Laid-open Patent Publication No. 2014-229124

Patent Literature 2: International Publication Pamphlet No. 2014/188940

However, according to the above-described technology, even if the target issue for learning is different, the learning epoch number is determined in a single uniform way; therefore, it is difficult to appropriately allocate the GA for conducting NN structure exploration and the number of times of repetition of the gradient method for conducting NN learning, and the learning accuracy of the NN is sometimes not desirable.

Generally, there is a trade-off relationship between exploration and learning on the structures of many NNs and estimation of the predicted error of an individual NN with accuracy. For example, for large-scale NN learning during deep learning, it takes too much time to learn all the NN structures. Meanwhile, even if it is the same NN, the predicted error of the NN is slightly changed at each learning. Furthermore, if the learning epoch number is increased, the predicted error of an NN is reduced; however, changes in the learning epoch number and the predicted error are different depending on the NN.

In this way, even if the number of times that the structure of the NN is explored is reduced and the learning epoch number for NN learning is determined in a single uniform way, as a change in the predicted error is different depending on an individual NN, it is sometimes difficult to sufficiently compare the predicted errors, and the learning accuracy of the NN causes variations.

### SUMMARY

According to a non-transitory computer-readable recording medium stores therein a learning program that causes a computer to execute a process. The process includes executing learning on each of a plurality of neural networks with regard to target data by duration of at least 1 epoch; executing a plurality times of loops of a specific algorithm, each of the plurality of times of loops changes a number of units of each of the plurality of neural networks; and setting a plurality of learning durations for each of the plurality of neural networks based on a respective accuracy variance and a respective actual performance, each of the plurality of learning durations being durations of the learning in each of the plurality of times of loops of the specific algorithm, the respective accuracy variance being variance values of accuracy for each of the plurality of neural networks immediately before start of the respective loop, and the respective actual performance being an actual performance of the plurality of neural networks with regard to the target data immediately before start of the respective loop.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram that illustrates the functional configuration of an information processing apparatus according to a first embodiment;

FIG. 2 is a diagram that illustrates an example of the information that is stored in a parameter table;

FIG. 3 is a diagram that illustrates an example of the information stored in a group table;

FIG. 4 is a diagram that illustrates an example of NN learning;

FIG. 5 is a diagram that illustrates an example of generation of a child individual through crossover;

FIG. 6 is a diagram that illustrates an example of update to the generation of a GA group;

FIG. 7 is a diagram that illustrates the setting of a termination epoch number;

FIG. 8 is a flowchart that illustrates the flow of a process; and

FIG. 9 is a diagram that illustrates an example of the hardware configuration.

### DESCRIPTION OF EMBODIMENTS

Preferred embodiments will be explained with reference to accompanying drawings. Furthermore, the present invention is not limited to the embodiments.

### a First Embodiment

### Explanations of an Information Processing Apparatus

An information processing apparatus 10, explained in the present embodiment, is applied to deep learning with a plurality of neural networks in multiple layers so that, after the number of intermediate layers is previously determined, the optimum number of units is explored by using a genetic algorithm (GA) or the like and, in addition, the coupling strength between units in different layers, or the like, is determined. Specifically, while the information processing apparatus 10 explores the number of units multiple times by using the GA, it repeats NN learning in a loop of the GA by using a stochastic gradient method, or the like, thereby exploring the optimum edge strength of the NN.

Specifically, the information processing apparatus 10 dynamically adjusts allocation of the time resources for the loop of the GA and the NN learning in the loop of the GA on the basis of the variance of fitness during the process of GA exploration. According to the present embodiment, while the number of layers is fixed, the optimum number of units with the maximum prediction accuracy is determined.

For example, the information processing apparatus 10 executes learning on each of the plurality of NNs with regard to the target data duration of at least 1 epoch. The information processing apparatus 10 performs the plurality times of loop of the GA, each of the plurality of times of loops changes a number of units of each of the plurality of NNs. Here, the information processing apparatus 10 sets the learning epoch number for each of the plurality of NNs based on the variance value of the accuracy for each of the plurality of NNs immediately before start of the respective loop and the actual performance of NN learning of the plurality of NNs with regard to the target data immediately before start of the respective loop.

In this way, when the information processing apparatus 10 performs the loop of the GA on multiple NNs, it sets the learning epoch number on the basis of the variance value of accuracy of the NNs immediately before the start of the loop and the actual performance of NN learning, whereby it is possible to properly allocate the time resources to the loop of the GA and the NN learning.

Furthermore, according to the present embodiment, the group of n individuals is sometimes described as a GA group, an individual as a neural network (NN), an error as the difference between the predicted value and the true value of the NN with regard to the data for validation, and the fitness as an error, or the like. Furthermore, a cross-validation error is used as an example of the error. Furthermore, the optimization of the NN structure means, for example, an update to the number of units in each layer of the NN by using the GA so as to reduce an error, and the NN training means, for example, an update to the coupling weight of the NN by using the stochastic gradient method so as to reduce an error. Furthermore, the epoch refers to, for example, the cycle in which every learning data is used once during NN training. Furthermore, in the present embodiment, an explanation is given by using a case where the GA is used; however, this is not a limitation, and a different learning algorithm may be used to change the number of units. Furthermore, learning methods other than the stochastic gradient method may be used, and error detection methods for other than the cross-validation error may also be used.

Functional Configuration of the Information Processing Apparatus

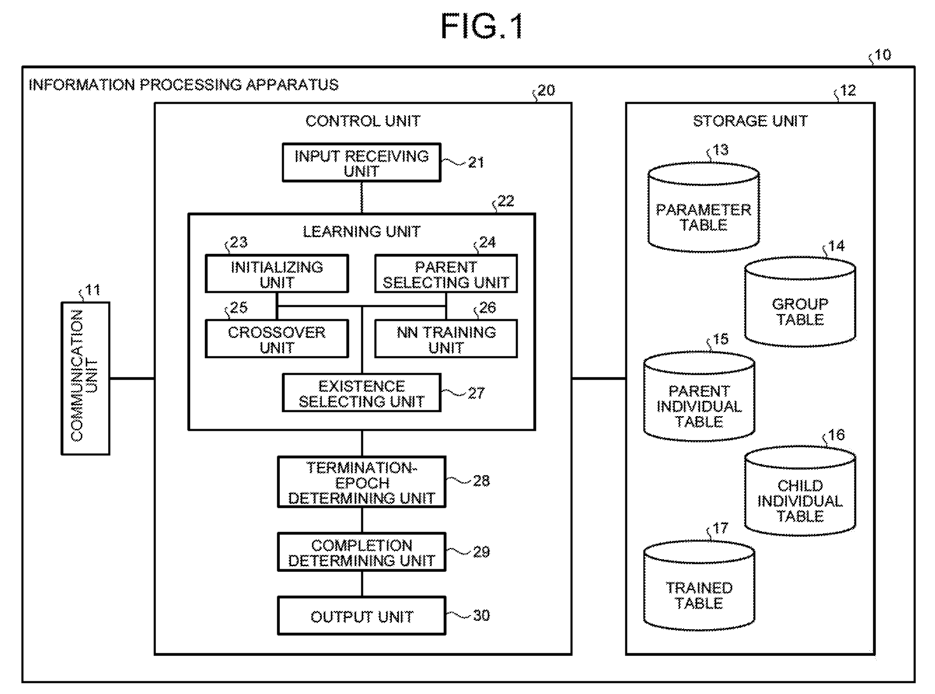

FIG. 1 is a functional block diagram that illustrates the functional configuration of the information processing apparatus according to the first embodiment. As illustrated in FIG. 1, the information processing apparatus 10 includes a communication unit 11, a storage unit 12, and a control unit 20. The communication unit 11 is a processing unit that controls the communication with a different device of an administrator, or the like, and it is for example a communication interface.

The storage unit 12 is a storage device that stores programs, data, or the like, and it is for example a memory or a hard disk. The storage unit 12 stores a parameter table 13, a group table 14, a parent individual table 15, a child individual table 16, and a trained table 17. Furthermore, an explanation is given here by using a table as a storage method; however, this is not a limitation, and a different format, such as database, may be also used.

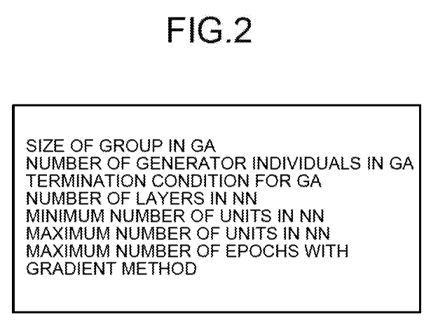

The parameter table 13 stores the information about the NN that is the training target. Specifically, the parameter table 13 stores the setting items, or the like, of the NN that is received from the administrator, or the like. FIG. 2 is a diagram that illustrates an example of the information that is stored in the parameter table 13. As illustrated in FIG. 2, the parameter table 13 stores “the size of group in the GA, the number of generator individuals in the GA, the termination condition for the GA, the number of layers in the NN, the minimum number of units in the NN, the maximum number of units in the NN, and the maximum number of epochs with the gradient method”.

The “size of group in the GA” stored here is the information for setting the number of NNs as the training target based on the assumption that one individual represents one NN. The “number of generator individuals in the GA” is the information for setting the number of new NNs that are generated at one time during a crossover process that is described later. The “termination condition for the GA” is the condition for terminating the learning flow, and it is set by the administrator, or the like. For example, the “termination condition for the GA” is that the individual (NN) is obtained, of which the predicted error is equal to or less than a certain value, or that a certain time has elapsed after the start of learning.

The “number of layers in the NN” is the number of intermediate layers included in the individual (NN), and it is set by the administrator, or the like. The “minimum number of units in the NN” is the minimum number of units that may be obtained by the NN, the “maximum number of units in the NN” is the maximum number of units that may be obtained by the NN, and each of them is set by the administrator, or the like. The “maximum number of epochs with the gradient method” is the maximum number of epochs with the stochastic gradient method for NN training, and it is set by the administrator, or the like.

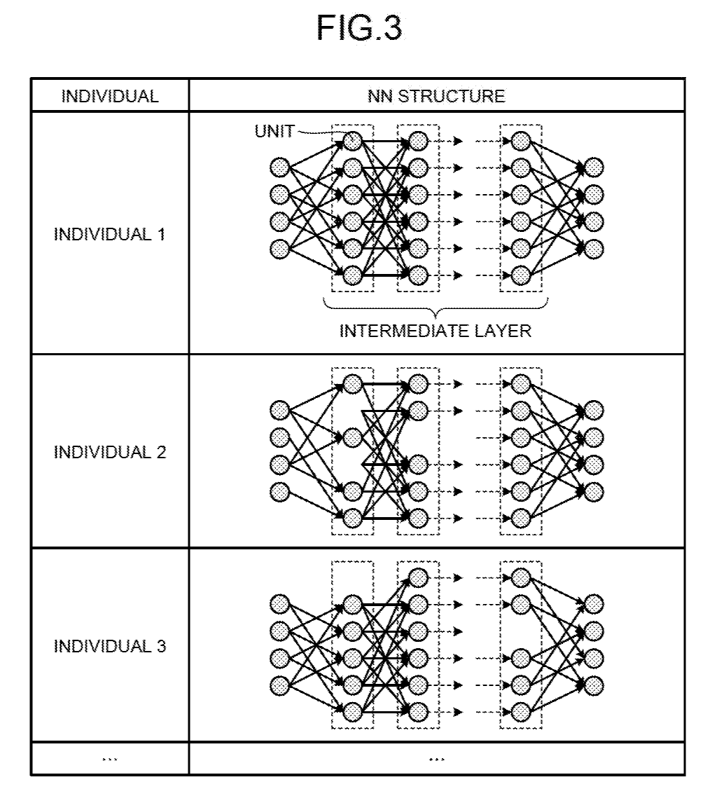

The group table 14 stores the GA group that is the learning target. Furthermore, the information stored here is generated by an initializing unit 23, or the like, which is described later. FIG. 3 is a diagram that illustrates an example of the information stored in the group table 14. As illustrated in FIG. 3, the group table 14 stores the individual and the NN structure in relation to each other.

The “individual” stored here is the identifier, or the like, for identifying the individual, i.e., the NN. The “NN structure” indicates the network structure of each individual, i.e., each NN. Here, the number of intermediate layers is fixed and identical with regard to the NN structure of each individual; however, the number of units in each layer is not always the same, and it is set for each NN structure. Furthermore, a unit corresponds to a circle in the NN structure of FIG. 3. For example, the number of units in the first layer out of the intermediate layers of an individual 1 is 6, and the number of units in the first layer out of the intermediate layers of an individual 2 is 4.

The parent individual table 15 stores the individual that is selected from the individuals (NNs) stored in the group table 14. The individual stored here is stored by a parent selecting unit 24 that is described later. The child individual table 16 stores the child individual that is generated from the parent individual stored in the parent individual table 15. The individual stored here is stored by a crossover unit 25 that is described later. The trained table 17 is a table that stores results of NN training, and it stores, for example, the result of NN training and the trained individual in relation to each other.

The control unit 20 is a processing unit that controls the overall information processing apparatus 10, and it is for example a processor. The control unit 20 includes an input receiving unit 21, a learning unit 22, a termination-epoch determining unit 28, a completion determining unit 29, and an output unit 30. For example, the input receiving unit 21, the learning unit 22, the termination-epoch determining unit 28, the completion determining unit 29, and the output unit 30 are examples of an electronic circuit, such as the processor, or examples of the process that is performed by the processor, or the like.

The input receiving unit 21 is a processing unit that receives the setting information about the NN, which is the training target, from the administrator, or the like. For example, the input receiving unit 21 receives “the size of group in the GA, the number of generator individuals in the GA, the termination condition for the GA, the number of layers in the NN, the minimum number of units in the NN, the maximum number of units in the NN, and the maximum number of epochs with the gradient method” and stores them in the parameter table 13.

The learning unit 22 is a processing unit that performs the GA loop for exploring the NN structure and the NN training by using the GA. The learning unit 22 includes the initializing unit 23, the parent selecting unit 24, the crossover unit 25, an NN training unit 26, and an existence selecting unit 27.

The initializing unit 23 is a processing unit that generates each individual, which is the target for NN training, and conducts initialization. Specifically, the initializing unit 23 generates the number of individuals (NNs), which is specified by the “size of group in the GA”, and stores them in the group table 14. For example, the initializing unit 23 generates the NN with the number of layers, specified by the “number of layers in the NN”, and determines the number of units in each layer by using a uniform random number between the “minimum number of units in the NN” and the “maximum number of units in the NN”. Furthermore, the initializing unit 23 makes the full linkage among the units and determines the coupling weight by using a uniform random number.

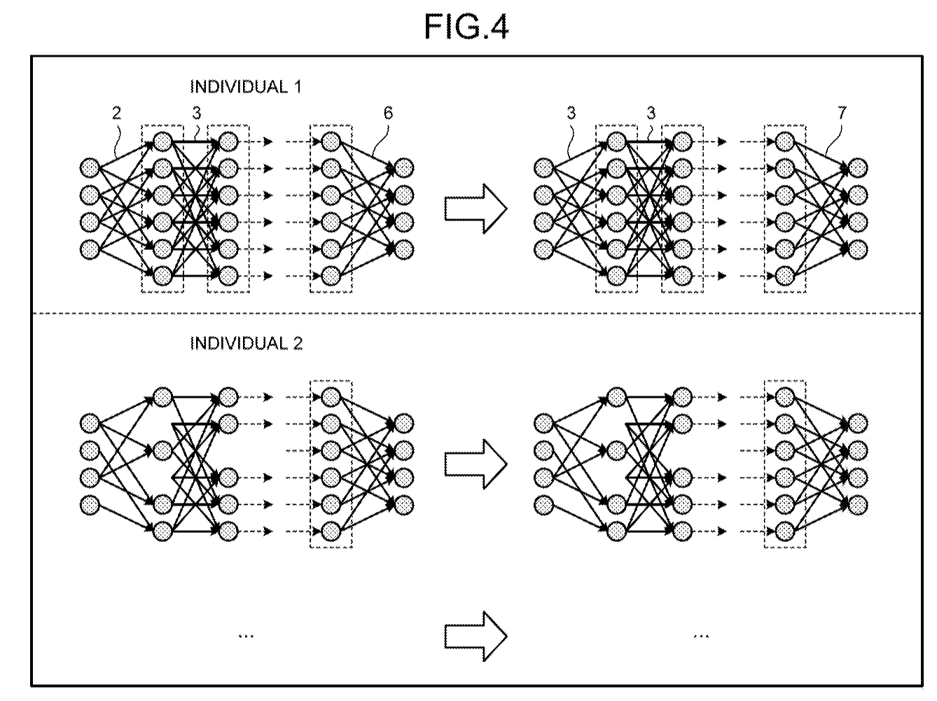

Then, the initializing unit 23 trains all the generated NNs by 1 epoch to learn the coupling weight. That is, all the NNs, stored in the group table 14, are the NNs after being learnt by 1 epoch. Here, an explanation is given of learning of NNs. FIG. 4 is a diagram that illustrates an example of NN learning. As illustrated in FIG. 4, a state is such that the coupling weight for the first unit in the input layer (the first layer) and the first unit in the second layer, which is the intermediate layer, is “2”, and the initializing unit 23 conducts learning by 1epoch so that the coupling weight is updated to “3”. Furthermore, in the example of FIG. 4, the coupling weight is kept to be “3” before and after learning, or the coupling weight is updated from “6” to “7”.

In this way, learning is conducted on each NN, generated on the basis of the input information, by 1 epoch so that the coupling weight is learnt. Then, the initializing unit 23 relates each individual with the predicted error of the individual and stores them in the group table 14, or the like.

Furthermore, the initializing unit 23 is capable of setting the initial value of the termination epoch number. For example, as learning is conducted on each NN in the GA group by 1 epoch, the initializing unit 23 may also set the initial value of the termination epoch number to “1”. Furthermore, the initializing unit 23 may also set the initial value of the termination epoch by using the variance value of the fitness of the GA group after 1 epoch learning. For example, the value, which is obtained by adding a predetermined value to the variance value, may be also set as the termination epoch number. Furthermore, the initial value may be set by the administrator, or the like, and the value is equal to or more than 1 and is equal to or less than the maximum number of epochs.

The parent selecting unit 24 is a processing unit that selects the parent GA for generating the NN that is the NN training target in the GA loop. For example, the parent selecting unit 24 selects two individuals from all the GAs, stored in the group table 14, in a random manner and stores the selected individuals as parent individuals in the parent individual table 15. Here, the parent selecting unit 24 selects the combination of parent individuals, corresponding to the input “number of generator individuals in the GA”.

The crossover unit 25 is a processing unit that generates a child individual from the two parent individuals, selected inn a random manner by the parent selecting unit 24. Specifically, the crossover unit 25 reads the combination of parent individuals from the parent individual table 15, generates a child individual, and stores it in the child individual table 16.

For example, if the number of units of an individual A is U_{A}, the number of units of an individual B is U₃, and U_{A}<U_{B}, the crossover unit 25 determines the number of units U_{C} of an individual C in the uniform distribution on the section [U_{A}, U_{B}]. Furthermore, if the (i, j) component of the weighting matrix of the individual A is W_{A}(i, j), and the (i, j) component of the weighting matrix of the individual B is W_{B}(i, j), the crossover unit 25 determines W_{C}(i, j), which is the (i, j) component of the weighting matrix of the individual C, as below. Specifically, (1) if i, j≦U_{A}, W_{C}(i, j) is determined in the uniform distribution on the section [W_{A}(i, j), W_{B}(i, j)]. (2) Otherwise, W_{C}(i, j) is determined in the uniform distribution on the section [0, W_{B}(i, j)].

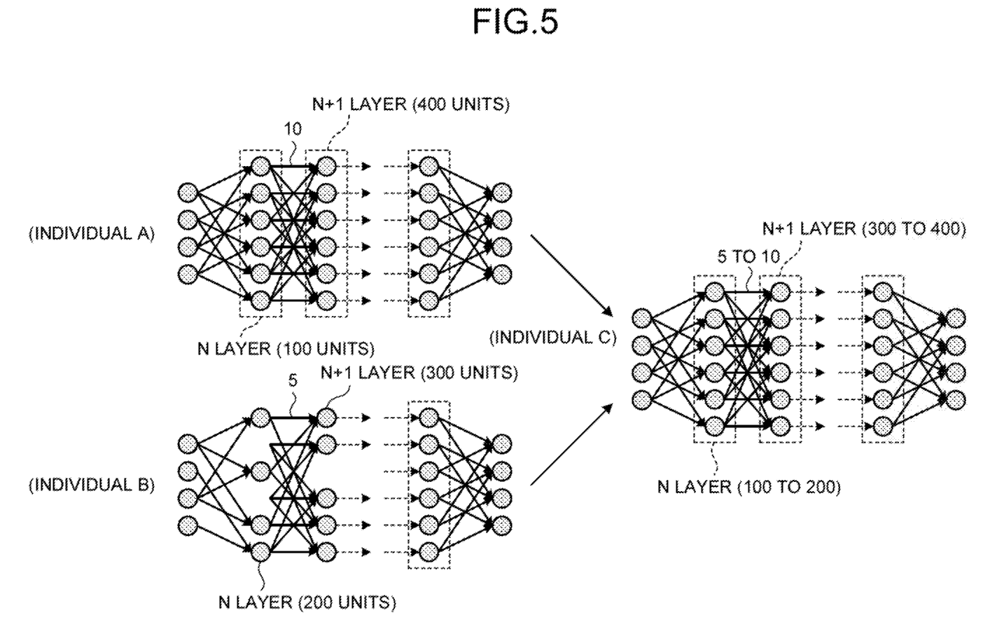

Here, an explanation is given of an example of generation of a child individual through crossover. FIG. 5 is a diagram that illustrates an example of generation of a child individual through crossover. As illustrated in FIG. 5, the crossover unit 25 generates the single child individual (the individual C) from the two parent individuals (the individual A, the individual B). Here, if the N layer of the individual A has 100 units and the N layer of the individual B has 200 units, the crossover unit 25 determines the number of units in the N layer of the individual C in the range from 100 to 200. In the same manner, if the N+1 layer of the individual A has 400 units and the N+1 layer of the individual B has 300 units, the crossover unit 25 determines the number of units in the N+1 layer of the individual C in the range from 300 to 400.

Furthermore, if the coupling weight for the first unit in the N layer of the individual A and the first unit in the N+1 layer is 10 and the coupling weight for the first unit in the N layer of the individual B and the first unit in the N+1 layer is 5, the crossover unit 25 determines the coupling weight for the first unit in the N layer of the individual C and the first unit in the N+1 layer in the range from 5 to 10. Here, various techniques, used in the GA, may be used as each determination technique.

The NN training unit 26 is a processing unit that conducts GA training on the individual (NN) stored in the child individual table 16. Specifically, with regard to each NN stored in the child individual table 16, the NN training unit 26 updates the coupling weight of the NN by using the stochastic gradient method so as to reduce an error. Furthermore, the NN training unit 26 populates the actual data into each trained (learnt) NN to measure the predicted error (prediction accuracy), relates each NN with the predicted error, and stores them in the trained table 17.

The NN training unit 26 conducts training, corresponding to the set termination epoch number. For example, during the first-time GA loop, the NN training unit 26 conducts training, corresponding to the termination epoch number that is set by the initializing unit 23. Afterward, training is conducted, corresponding to the termination epoch number that is set by the termination-epoch determining unit 28 that is described later.

The existence selecting unit 27 is a processing unit that selects a new-generation GA group from the NN-trained GA groups. Specifically, the existence selecting unit 27 selects the GA group with a small predicted error and a desirable prediction accuracy and selects the target on which the next GA loop is executed. Specifically, the existence selecting unit 27 selects the individual with a small predicted error from the individuals stored in the group table 14 and the individuals stored in the trained table 17 and stores it in the group table 14. That is, the existence selecting unit 27 generates a new GA group.

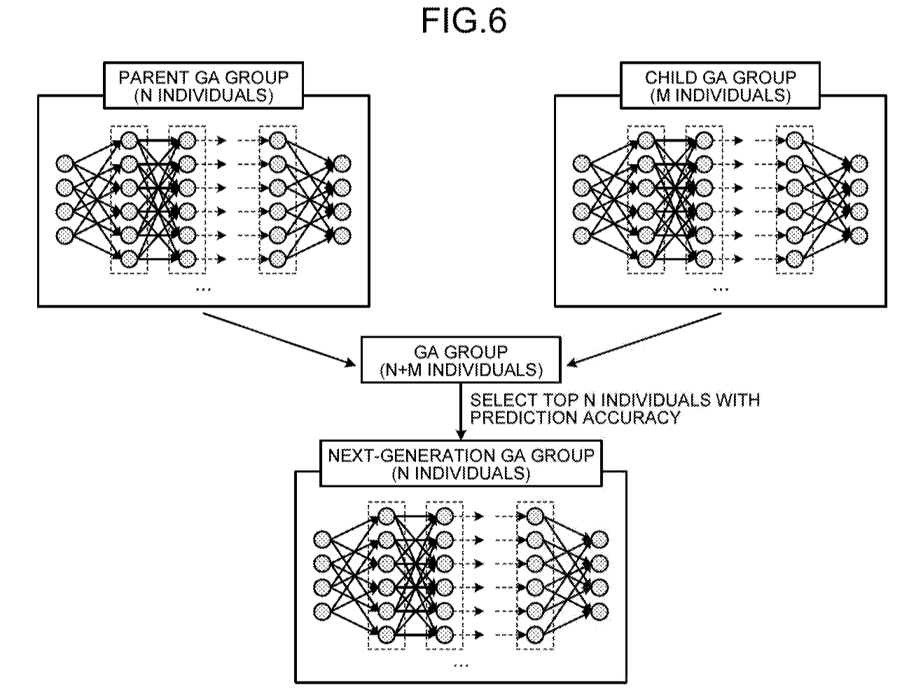

FIG. 6 is a diagram that illustrates an example of update to the generation of the GA group. As illustrated in FIG. 6, the existence selecting unit 27 reads N individuals stored in the group table 14 and M child individuals stored in the trained table 17, thereby acquiring (N+M) individuals. Then, the existence selecting unit 27 selects the top N individuals with a small predicted error (desired prediction accuracy) from the read (N+M) individuals. Then, the existence selecting unit 27 relates the selected top N individuals with the predicted error and stores them in the group table 14.

The termination-epoch determining unit 28 is a processing unit that determines the termination epoch number for terminating NN training. Specifically, with regard to the next-generation GA group, the termination-epoch determining unit 28 determines the termination epoch number in accordance with the variance value of fitness of each individual (NN) included in the GA group. For example, the termination-epoch determining unit 28 determines the termination epoch number after each NN, generated by the initializing unit 23 during initialization, is learnt by 1 epoch, or when the completion determining unit 29, which is described later, determines that the next-generation NN does not satisfy the completion condition.

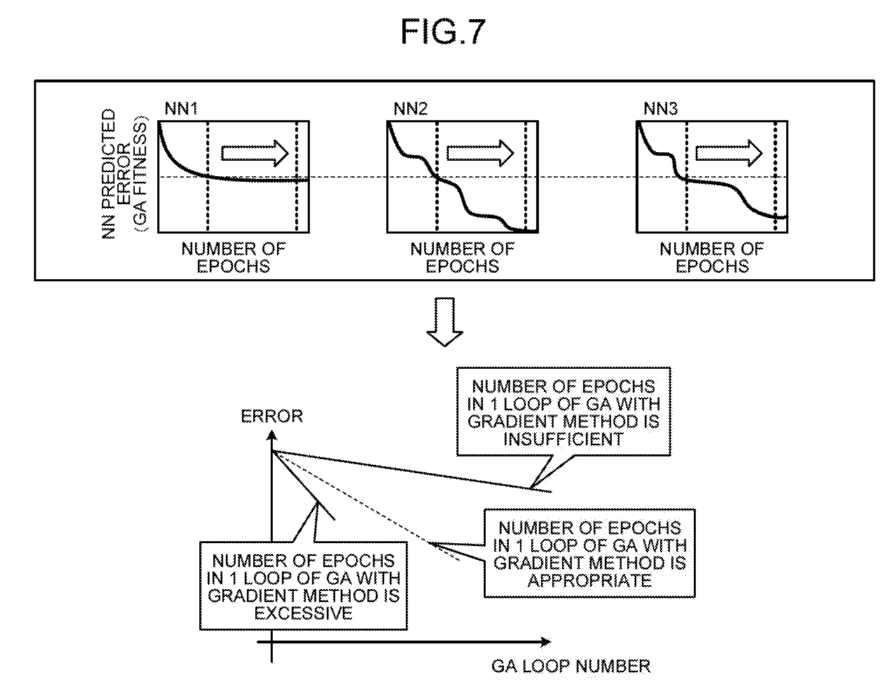

Here, an explanation is given of an example of determination of the termination epoch number. FIG. 7 is a diagram that illustrates the setting of the termination epoch number. The transition of the predicted error of an NN is different depending on the target issue or the structure of the NN. In the example of FIG. 7, the predicted error of an NN 1 becomes small at the early stage of learning, and an NN 2 and an NN 3 do not have a specific cycle until the latter stage of learning. Therefore, it is preferable to set the termination epoch number at the early stage of learning in the case of the NN 1, and it is preferable to set the termination epoch number at the latter stage of learning in the case of the NN 2 or the NN 3. That is, as illustrated in FIG. 7, with regard to the NN training, there are the NN for which the number of epochs in 1 loop of the GA with the gradient method is insufficient, the NN for which the number of epochs in 1 loop of the GA with the gradient method is excessive, and the NN for which the number of epochs in 1 loop of the GA with the gradient method is appropriate.

As described above, if the number of epochs for NN training is terminated at a certain small number, there is a high possibility of occurrence of the NN that is hardly learnt, which causes a decrease in the prediction accuracy. Furthermore, if the number of epochs for NN training is larger, the learning time becomes longer although the prediction accuracy is improved. Therefore, according to the present embodiment, the termination epoch number is set such that the predicted error of the individual NN is accurately estimated. Specifically, the termination epoch number is increased or decreased on the basis of the variance value of fitness of the GA group so that learning is enabled to such a degree that the prediction accuracy is determinable.

For example, the termination-epoch determining unit 28 reads the predicted error of each NN, selected by the existence selecting unit 27, from the group table 14. Next, the termination-epoch determining unit 28 calculates the variance value (S) of the read predicted error of each NN. Then, if the variance value (S) is smaller than the predetermined threshold “ε” for the variance of fitness of the GA group, the termination-epoch determining unit 28 sets the value, which is obtained by incrementing the previous-generation termination epoch number by 1, as the new termination epoch number. Furthermore, if the variance value (S) is equal to or more than the predetermined threshold “ε” for the variance of fitness of the GA group, the termination-epoch determining unit 28 sets the value, which is obtained by decrementing the previous-generation termination epoch number by 1, as the new termination epoch number.

In this way, if the variance value of the predicted error of each NN is large, the number of epochs is decreased and, if the variance value of the predicted error of each NN is small, the number of epochs is increased, whereby learning is conducted until the predicted error of the NN has a sufficient difference.

The completion determining unit 29 is a processing unit that determines whether each NN, stored in the group table 14, satisfies the completion condition. For example, each time the loop of NN training is completed, the completion determining unit 29 determines whether “the individual (NN) is obtained, of which the predicted error is equal to or less than a certain value”, “a certain time has elapsed”, or the like, as the completion condition with regard to each NN stored in the group table 14. Furthermore, if the completion condition is satisfied, the completion determining unit 29 gives a command to the output unit 30 to start processing and, if the completion condition is not satisfied, gives a command to the termination-epoch determining unit 28 to start processing.

The output unit 30 is a processing unit that selects and outputs the individual with the smallest predicted error and with the high prediction accuracy. For example, if the output unit 30 receives a command from the completion determining unit 29 to start processing, it reads each NN, stored in the group table 14, and the predicted error of each NN. Then, the output unit 30 selects the NN with the smallest predicted error and outputs the selected NN to the previously designated output destination. For example, the output unit 30 causes a display unit, such as a display or a touch panel, to present the selected NN or transmits the selected NN to the administrator's terminal.

Flow of a Process

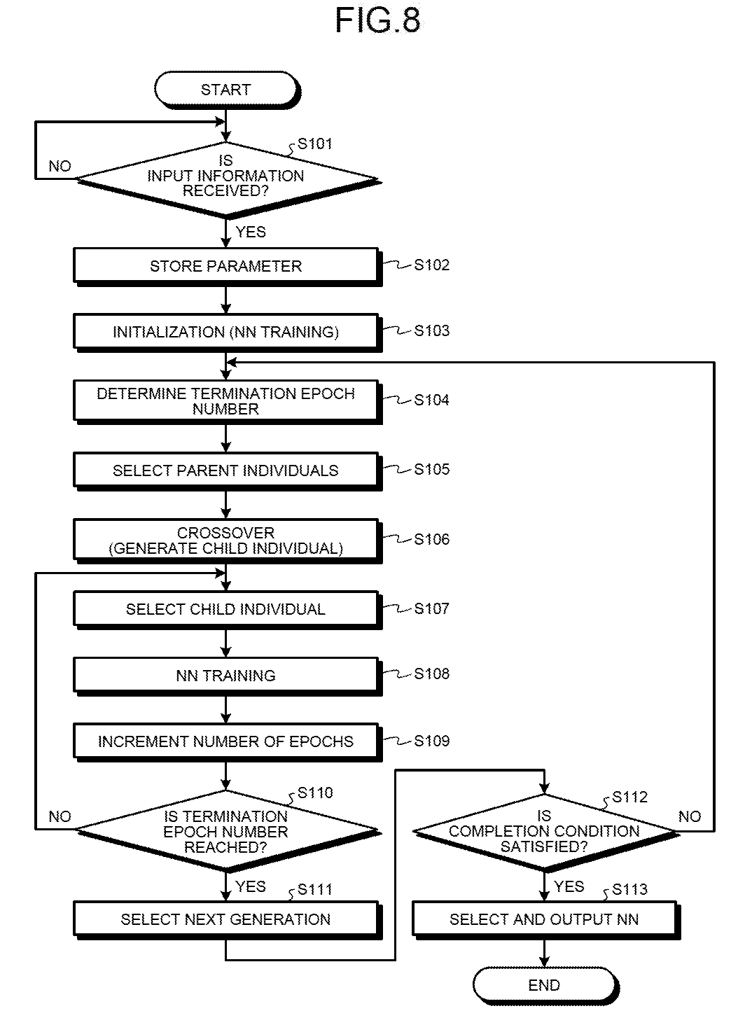

FIG. 8 is a flowchart that illustrates the flow of a process. As illustrated in FIG. 8, when the input receiving unit 21 receives the input information (S101: Yes), it stores the received input information as a parameter in the parameter table 13 (S102).

Next, the initializing unit 23 executes initialization on the GA group and conducts learning on each of the generated NNs by 1 epoch (S103). Then, the termination-epoch determining unit 28 determines the termination epoch number by using the first-time NN training result (S104).

Then, the parent selecting unit 24 selects the two GAs as parent individuals from the group table 14 in a random manner (S105), and the crossover unit 25 generates a child individual from the two selected parent individuals (S106).

Next, the NN training unit 26 selects a child individual from the child individual table 16 (S107) and conducts NN training (S108). Then, the NN training unit 26 increments the number of epochs when the NN training is completed (S109) and repeats S107 and the subsequent steps until the termination epoch number is reached (S110: No). Furthermore, the NN training unit 26 executes S107 to S110 on each of the child individuals that are stored in the child individual table 16.

Then, when the termination epoch number is reached (S110: Yes), the existence selecting unit 27 selects the next-generation NN, which is the next training target, from the NNs stored in the group table 14 and the NNs stored in the trained table 17 (S111).

Then, if the completion determining unit 29 determines that the selected next-generation NN does not satisfy the completion condition (S112: No), S104 and the subsequent steps are repeated. Conversely, if the completion determining unit 29 determines that the selected next-generation NN satisfies the completion condition (S112: Yes), the output unit 30 selects and outputs the single NN (S113).

Advantage

As described above, it is possible to automatically conduct NN structure tuning at a high speed, which is usually conducted through a trial and error process by a specialist. Furthermore, there is a trade-off relationship between examination on many NN structures and accurate estimation of the predicted error of an individual NN if it is difficult to sufficiently learn all the NN structures. However, by using the technique according to the present embodiment, it is possible to properly allocate the GA for conducting NN structure exploration and the number of times of repetition of the gradient method for conducting NN learning. As a result, while the number of times of NN learning is reduced, the termination epoch number may be set such that the predicted error of an individual NN is estimated with accuracy, whereby the learning time for the NN may be reduced, while a reduction in the learning accuracy of the NN may be prevented.

Furthermore, the information processing apparatus 10 updates the termination epoch number for the next learning during each learning; therefore, the termination epoch number may be determined in accordance with a predicted error during learning, and a reduction in the accuracy of NN learning may be prevented.

### b Second Embodiment

Furthermore, although the embodiment according to the present invention has been explained above, the present invention may be implemented in various different embodiments other than the above-described embodiment.

Increase or Decrease in the Learning Epoch Number

In the above-described embodiment, an explanation is given of a case where the termination epoch number is increased or decreased by 1 in accordance with the fitness (predicted error) of the GA group; however, this is not a limitation, and it may be increased or decreased by a predetermined number, such as 2. Furthermore, if the difference between the fitness and the threshold is less than a predetermined value, it may be increased or decreased by 1 and, if the difference between the fitness and the threshold is equal to or more than a predetermined value, it may be increased or decreased by 2.

System

Furthermore, components of each device, illustrated in FIG. 1, do not always need to be physically configured as illustrated in the drawings. Specifically, they may be configured in separation or combination in any unit. For example, the learning unit 22 and the termination-epoch determining unit 28 may be combined. Furthermore, all or any part of various processing functions performed by each device may be implemented by a central processing unit (CPU) or a program that is analyzed and executed by the CPU, or they may be implemented as wired logic hardware.

Furthermore, among the processes described in the present embodiment, all or some of the processes that are automatically performed as described may be performed manually. Furthermore, all or some of the processes that are manually performed as described may be performed automatically by using a well-known method. Furthermore, processing procedures, control procedures, specific names, and the information including various types of data and parameters as described in the above specifications and the drawings may be optionally changed except as otherwise noted.

Hardware

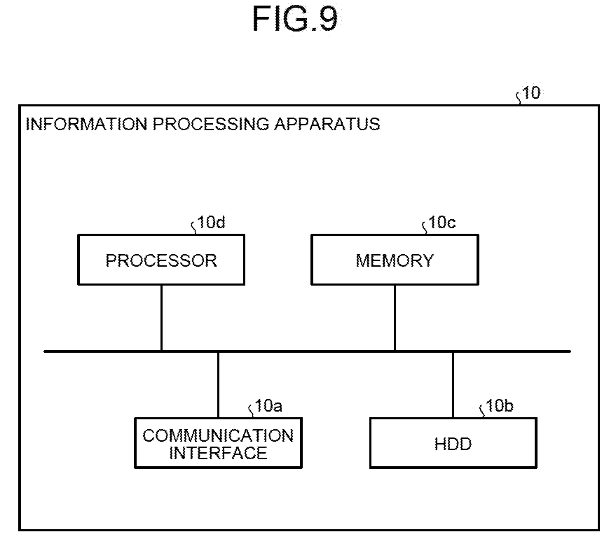

The above-described information processing apparatus 10 may be implemented by a computer that has, for example, the following hardware configuration. FIG. 9 is a diagram that illustrates an example of the hardware configuration. As illustrated in FIG. 9, the information processing apparatus 10 includes a communication interface 10a, a hard disk drive (HDD) 10b, a memory 10c, and a processor 10d.

An example of the communication interface 10a is a network interface card. The HDD 10b is a storage device that stores various DBs that are illustrated in FIG. 3.

Examples of the memory 10c include a random access memory (RAM), such as a synchronous dynamic random access memory (SDRAM), a read only memory (ROM), or a flash memory. Examples of the processor 10d include a CPU, digital signal processor (DSP), field programmable gate array (FPGA), or programmable logic device (PLD).

Furthermore, the information processing apparatus 10 is operated as an information processing apparatus that implements a learning method by reading and executing programs. Specifically, the information processing apparatus 10 executes programs for implementing the same functionalities as the input receiving unit 21, the learning unit 22, the termination-epoch determining unit 28, the completion determining unit 29, and the output unit 30. As a result, the information processing apparatus 10 may perform processes for implementing the same functionalities as the input receiving unit 21, the learning unit 22, the termination-epoch determining unit 28, the completion determining unit 29, and the output unit 30. Furthermore, the programs in this different embodiment are not limited to being executed by the information processing apparatus 10. For example, the present invention is applicable in the same manner in a case where the programs are executed by a different computer or server or a case where the programs are executed in cooperation with them.

The programs may be distributed via a network, such as the Internet. Furthermore, the programs are recorded in a recording medium readable by a computer, such as a hard disk, a flexible disk (FD), CD-ROM, magnet-optical disk (MO), digital versatile disc (DVD), and it may be executed by being read from the recording medium by the computer.

According to the embodiments, during learning that uses a neural network, it is possible to properly allocate the time resources for the external loop for changing the number of units and learning on an individual NN.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a learning program that causes a computer to execute a process comprising:
executing learning on each of a plurality of neural networks with regard to target data by duration of at least 1 epoch;
executing a plurality times of loops of a specific algorithm, each of the plurality of times of loops changes a number of units of each of the plurality of neural networks; and
setting a plurality of learning durations for each of the plurality of neural networks based on a respective accuracy variance and a respective actual performance, each of the plurality of learning durations being durations of the learning in each of the plurality of times of loops of the specific algorithm, the respective accuracy variance being variance values of accuracy for each of the plurality of neural networks immediately before start of the respective loop, and the respective actual performance being an actual performance of the plurality of neural networks with regard to the target data immediately before start of the respective loop.

2. The non-transitory computer-readable recording medium according to claim 1, further comprising, generating a plurality of new neural networks whose number is identical to a number of the plurality of neural networks, wherein
the setting includes setting a plurality of learning durations for each of the plurality of new neural networks each time the plurality of new neural networks are generated, and
the executing includes executing the plurality times of loops of the specific algorithm on the plurality of new neural networks by the plurality of learning durations.

3. The non-transitory computer-readable recording medium according to claim 2, wherein the setting includes, in a case where a variance value of the accuracy of each of the plurality of neural networks, which are previous execution targets, is equal to or more than a threshold, determining that the plurality of learning durations for the plurality of new neural networks is a value that is obtained by subtracting a predetermined number from a plurality of previous learning durations and, in a case where the variance value of the accuracy of each of the plurality of neural networks, which are the previous execution targets, is less than the threshold, determining that the plurality of learning durations is a value that is obtained by adding a predetermined number to the plurality of previous learning durations.

4. The non-transitory computer-readable recording medium according to claim 1, wherein the specific algorithm is a genetic algorithm.

5. A learning method comprising:
executing learning on each of a plurality of neural networks with regard to target data by duration of at least 1 epoch, using a processor;
executing a plurality times of loops of a specific algorithm, each of the plurality of times of loops changes a number of units of each of the plurality of neural networks, using the processor; and
setting a plurality of learning durations for each of the plurality of neural networks based on a respective accuracy variance and a respective actual performance, each of the plurality of learning durations being durations of the learning in each of the plurality of times of loops of the specific algorithm, the respective accuracy variance being variance values of accuracy for each of the plurality of neural networks immediately before start of the respective loop, and the respective actual performance being an actual performance of the plurality of neural networks with regard to the target data immediately before start of the respective loop, using the processor.

6. The learning method according to claim 5, further comprising,
generating a plurality of new neural networks whose number is identical to a number of the plurality of neural networks, using the processor, wherein
the setting includes setting a plurality of learning durations for each of the plurality of new neural networks each time the plurality of new neural networks are generated, and
the executing includes executing the plurality times of loops of the specific algorithm on the plurality of new neural networks by the plurality of learning durations.

7. The learning method according to claim 6, wherein the setting includes, in a case where a variance value of the accuracy of each of the plurality of neural networks, which are previous execution targets, is equal to or more than a threshold, determining that the plurality of learning durations for the plurality of new neural networks is a value that is obtained by subtracting a predetermined number from a plurality of previous learning durations and, in a case where the variance value of the accuracy of each of the plurality of neural networks, which are the previous execution targets, is less than the threshold, determining that the plurality of learning durations is a value that is obtained by adding a predetermined number to the plurality of previous learning durations.

8. The learning method according to claim 5, wherein the specific algorithm is a genetic algorithm.

9. An information processing apparatus comprising:
a processor that executes a process including:
executing learning on each of a plurality of neural networks with regard to target data by duration of at least 1 epoch;
executing a plurality times of loops of a specific algorithm, each of the plurality of times of loops changes a number of units of each of the plurality of neural networks; and
setting a plurality of learning durations for each of the plurality of neural networks based on a respective accuracy variance and a respective actual performance, each of the plurality of learning durations being durations of the learning in each of the plurality of times of loops of the specific algorithm, the respective accuracy variance being variance values of accuracy for each of the plurality of neural networks immediately before start of the respective loop, and the respective actual performance being an actual performance of the plurality of neural networks with regard to the target data immediately before start of the respective loop.

10. The information processing apparatus according to claim 9, wherein the process further includes generating a plurality of new neural networks whose number is identical to a number of the plurality of neural networks, wherein the setting includes setting a plurality of learning durations for each of the plurality of new neural networks each time the plurality of new neural networks are generated, and the executing includes executing the plurality times of loops of the specific algorithm on the plurality of new neural networks by the plurality of learning durations.

11. The information processing apparatus according to claim 10, wherein the setting includes, in a case where a variance value of the accuracy of each of the plurality of neural networks, which are previous execution targets, is equal to or more than a threshold, determining that the plurality of learning durations for the plurality of new neural networks is a value that is obtained by subtracting a predetermined number from a plurality of previous learning durations and, in a case where the variance value of the accuracy of each of the plurality of neural networks, which are the previous execution targets, is less than the threshold, determining that the plurality of learning durations is a value that is obtained by adding a predetermined number to the plurality of previous learning durations.

12. The information processing apparatus according to claim 9, wherein the specific algorithm is a genetic algorithm.
